(19) United States
(12) Patent Application Publication
(10) Pub. No.: US 2026/0273634 A1
(43) Pub. Date: Sep. 17, 2026

(54) CUTTING TABLE FOR BUILDING MATERIALS

(71) Applicant: HUI-CHUAN LIAO, Oakland, CA (US)

(72) Inventor: HUI-CHUAN LIAO, Oakland, CA (US)

(21) Appl. No.: 19/078,049

(22) Filed: Mar. 12, 2025

(51) Int. Cl. B23D 47/02; B23D 45/06; B25H 1/02

(52) U.S. Cl. CPC B23D 47/025; B23D 45/061; B25H 1/02

(57) ABSTRACT

A cutting table for building materials has a pedestal, a cutting device, and at least one clamping device. The pedestal has two leg frames and multiple supporting rods. The cutting device is connected to the pedestal and has a track base and a cutter. The cutter is connected to the track base and has a measuring arm and a cutting mount movably mounted on the measuring arm with a cutting wheel. The at least one clamping device is connected to the pedestal and has a clamping mount and a pressing rod. The clamping mount has a base portion and two clamping arms pivotally connected to the base portion. The clamping arms engage with one of the leg frames and one of the supporting rods. The pressing rod is rotatably connected to the base portion and selectively presses against the corresponding leg frame.

### BACKGROUND

### 1. Technical Field

The present invention relates to a cutting table, and more particularly to a cutting table for building materials that facilitates ease in cutting, reduces collision damage, and is safe to use.

### 2. Description of Related Art

Building materials such as glass, tiles, and sintered stones often need to be cut into corresponding shapes and sizes according to users'needs. During cutting, the building material is usually put on the ground, and several pads are set between the building material and the ground. A cutting tool is used to form a cutting line on the building material, and a clamper is used to clamp the building material at the cutting line, so that the building material is broken and separated along the cutting line to obtain a building material of the required size after cutting.

Although the above-mentioned cutting method can provide a cutting effect for building materials, the user needs to squat on the ground to place the building material, operates the cutting tool, and clamps the clamper, which is relatively inconvenient for the user to operate. Furthermore, during the squatting operation, the user may easily collide with the building material or surrounding objects, and this will cause the user to be injured or the building material to be damaged or broken, which leads to safety and usage concerns. Therefore, the conventional cutting method for building materials has the above-mentioned problems and deficiencies and needs improvement.

The cutting table for building materials in accordance with the present invention mitigates or obviates the aforementioned problems.

### SUMMARY OF THE INVENTION

The main objective of the present invention is to provide a cutting table for building materials that facilitates ease in cutting, reduces collision damage, and is safe to use.

The cutting table for building materials in accordance with the present invention has a pedestal, a cutting device, and at least one clamping device. The pedestal has two leg frames and multiple supporting rods disposed on the two leg frames. The cutting device is connected to the pedestal and has a track base and a cutter. The cutter is connected to the track base and has a measuring arm disposed on the cutter and extended above the pedestal and a cutting mount movably mounted on the measuring arm and having a cutting wheel. The at least one clamping device is connected to the pedestal and has a clamping mount and a pressing rod. The clamping mount has a base portion and two clamping arms pivotally connected to the base portion. The clamping arms engage with one of the two leg frames and one of the multiple supporting rods. The pressing rod is rotatably connected to the base portion and selectively presses against the corresponding leg frame.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a cutting table for building materials in accordance with the present invention;

FIG. 2 is an enlarged and partial perspective side view of the cutting table for building materials in FIG. 1;

FIG. 3 is an enlarged and exploded perspective view of the cutting table for building materials in FIG. 1;

FIG. 3A is a further enlarged and exploded perspective view of the cutting table for building materials in FIG. 3;

FIG. 4 is another enlarged and exploded perspective view of the cutting table for building materials in FIG. 1;

FIG. 5 is another enlarged and partial perspective side view of the cutting table for building materials in FIG. 1;

FIG. 6 is an enlarged and partial perspective top side view of the cutting table for building materials in FIG. 1;

FIG. 7 is an operational perspective side view in partial section of the cutting table for building materials in FIG. 1;

FIG. 8 is another operational perspective side view in partial section of the cutting table for building materials in FIG. 1;

FIG. 9 is an operational perspective view of the cutting table for building materials in FIG. 1, for cutting a building material; and

FIG. 10 is an enlarged operational perspective side view of the cutting table for building materials in FIG. 9, for cutting the building material.

### DETAILED DESCRIPTION OF THE PREFERRED EMBODIMENTS

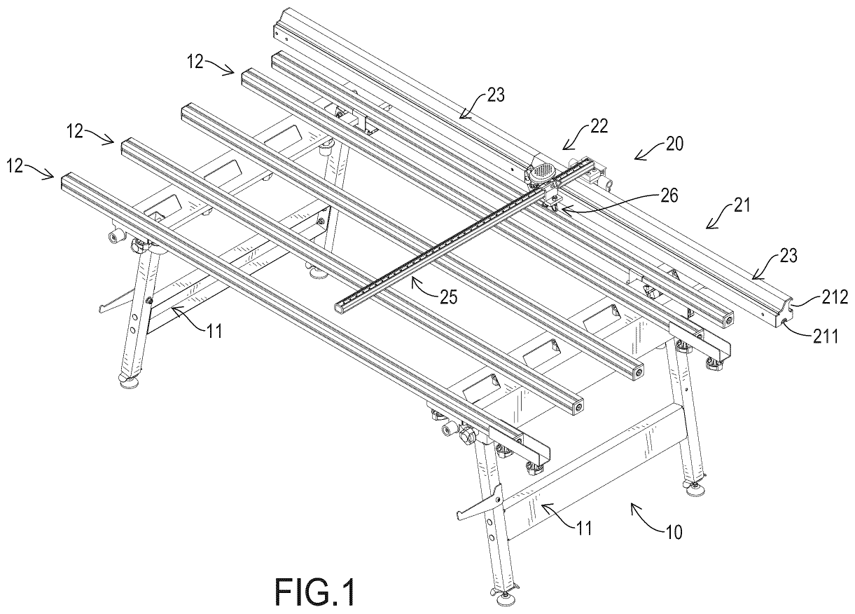

With reference to FIG. 1, a cutting table for building materials in accordance with the present invention has a pedestal 10, a cutting device 20, and at least one clamping device 30.

With reference to FIGS. 1, 3, and 4, the pedestal 10 has two leg frames 11 and multiple supporting rods 12. The two leg frames 11 are disposed at a spaced interval, face to each other, and each one of the two leg frames 11 has a connecting block 13 disposed on a top face of the leg frame 11 adjacent to a side of the leg frame 11, and a rotating knob 14 disposed on a bottom face of the leg frame 11 and connected to the connecting block 13. The connecting block 13 can be moved toward or away from the top face of the leg frame 11 by rotating the rotating knob 14 relative to the leg frame 11. The multiple supporting rods 12 are disposed on the top faces of the two leg frames 11 at spaced intervals, and two ends of each one of the multiple supporting rods 12 respectively extend out of the two leg frames 11.

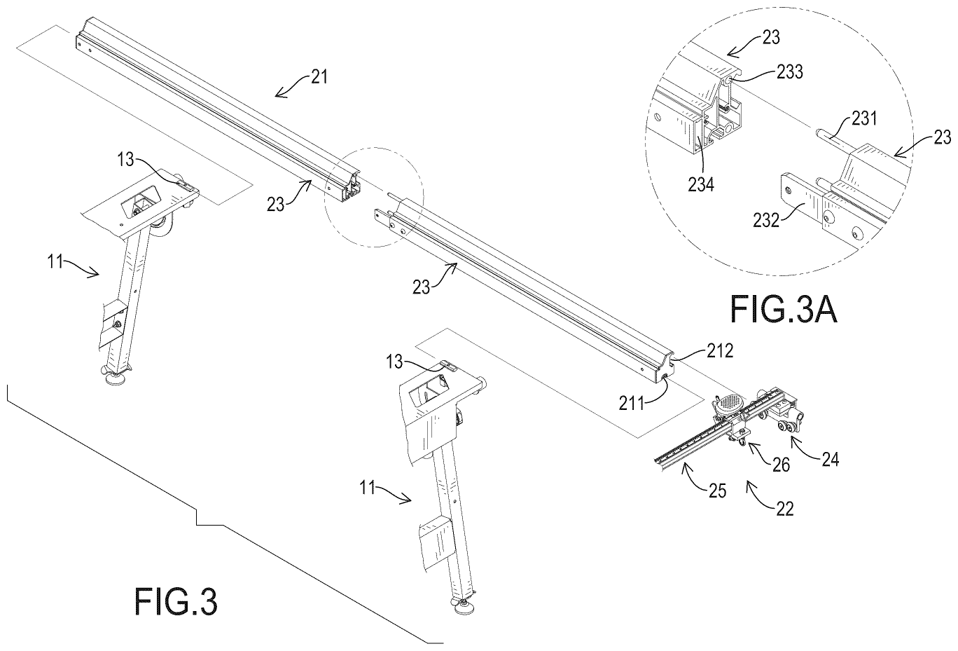

With reference to FIGS. 1 to 4, the cutting device 20 is connected to the pedestal 10 and has a track base 21 and a cutter 22. The track base 21 is elongated and may be formed by multiple rails 23 connecting to each other. With reference to FIGS. 3 and 3A, one of two adjacent rails 23 of the multiple rails 23 has multiple inserting pins 231 and multiple positioning slices 232, and the other one of the two adjacent rails 23 has multiple pin holes 233 and multiple positioning slots 234. The two adjacent rails 23 are connected to each other by the inserting pins 231 inserted into the pin holes 233 and the positioning slices 232 mounted in the positioning slots 234.

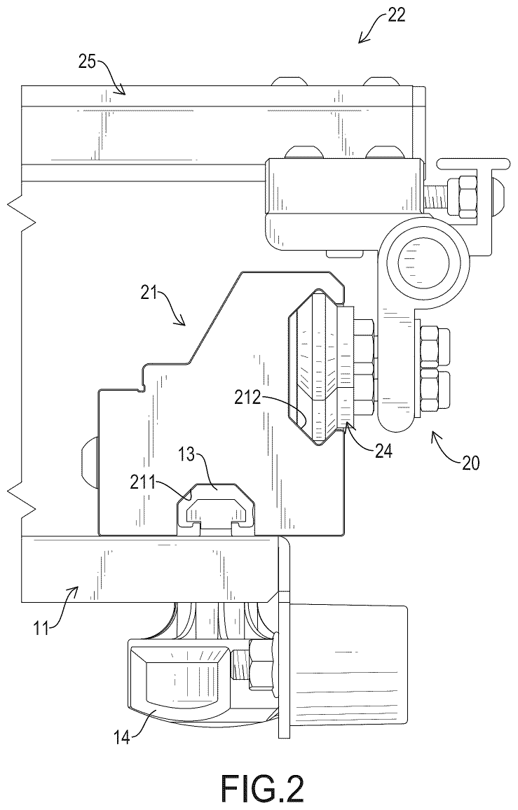

With reference to FIGS. 2 and 3, the track base 21 has a connecting recess 211 formed in a bottom side of the track base 21 and extended along a length direction of the track base 21. The connecting recess 211 of the track base 21 is connected to the two connecting blocks 13 of the two leg frames 11, and the track base 21 is securely mounted on the top faces of the two leg frames 11 by rotating the two rotating knobs 14 to respectively enable the two connecting blocks 13 to respectively move toward the top faces of the two leg frames 11. Then the track base 21 is disposed on the top faces of the two leg frames 11, and the multiple supporting rods 12 are arranged at spaced intervals on a side of each one of the two leg frames 11. In addition, the track base 21 has a pulley groove 212 formed in an outer side of the track base 21 away from the multiple supporting rods 12 and extended along the length direction of the track base 21.

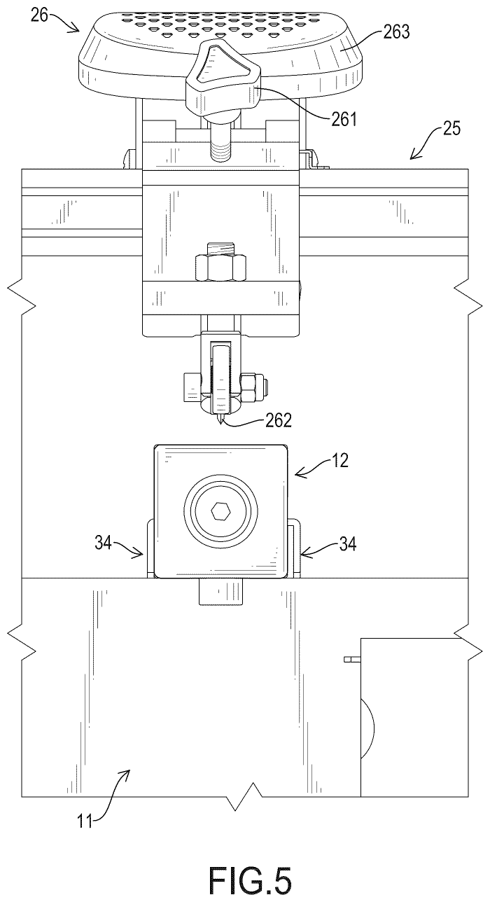

With reference to FIGS. 2 to 4, the cutter 22 is slidably connected to the track base 21 and has multiple pulleys 24, a measuring arm 25, and a cutting mount 26. The multiple pulleys 24 are rotatably disposed at spaced intervals on an inner side of the cutter 22 and are slidably mounted in the pulley groove 212 of the track base 21. Then the cutter 22 is slid relative to the track base 21 by the multiple pulleys 24. The measuring arm 25 is transversally disposed on a top side of the cutter 22, crosses the track base 21, and extends above the pedestal 10. The measuring arm 25 has a scale 251 formed on a top side of the measuring arm 25 for cutting. The cutting mount 26 is movably mounted on the measuring arm 25 and has a fastener 261, a cutting wheel 262, and an operating stem 263. The fastener 261 is connected to the cutting mount 26 and selectively abuts against the measuring arm 25 to hold the cutting mount 26 securely on the measuring arm 25. With reference to FIG. 5, the cutting wheel 262 is rotatably disposed on a bottom of the cutting mount 26 and faces to one of the multiple supporting rods 12. The operating stem 263 is disposed on a top of the cutting mount 26, and is used by a user to push the cutting mount 26 via the pulleys 24, such that the cutter 22 can move along the track base 21 relative to the pedestal 10.

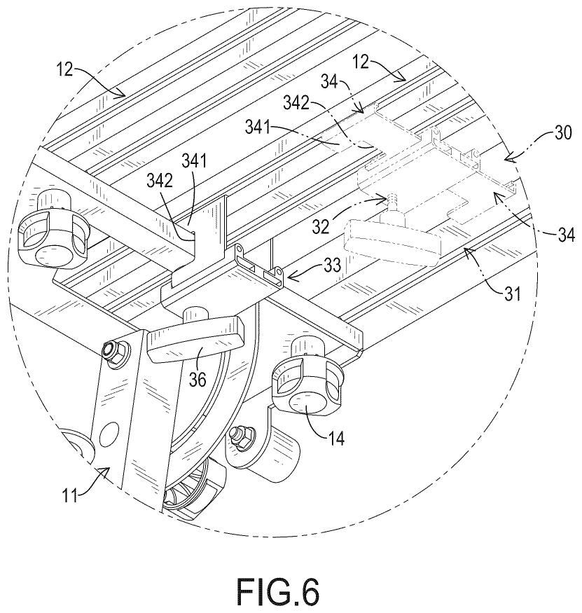

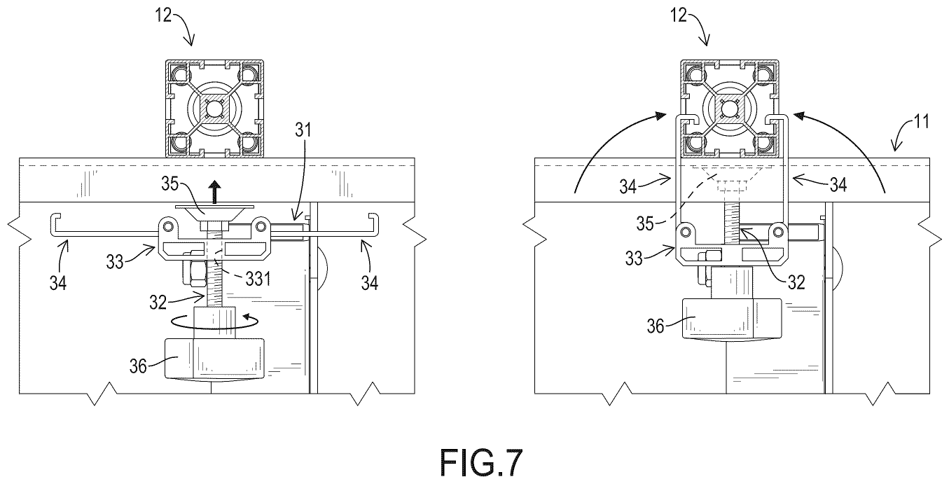

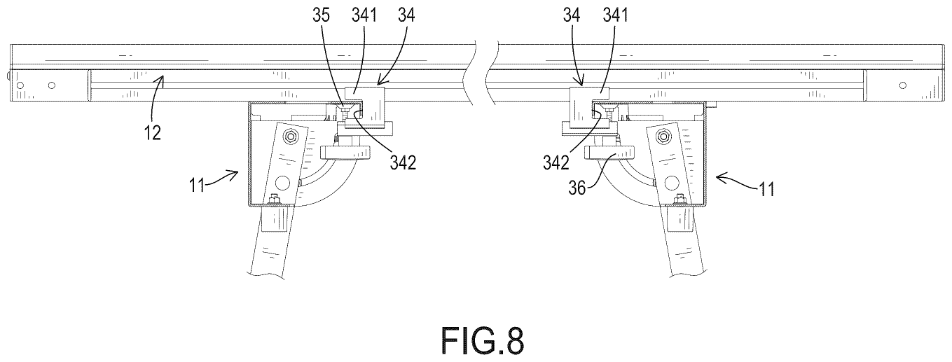

With reference to FIGS. 6 to 8, the at least one clamping device 30 is connected to the pedestal 10; preferably, the cutting table of the present invention has two said clamping devices 30. With reference to FIGS. 1 and 8, the two clamping devices 30 are respectively disposed at the two leg frames 11 to hold one of the multiple supporting rods 12 securely on the top faces of the two leg frames 11. Each one of the two clamping devices 30 has a clamping mount 31 and a pressing rod 32. The clamping mount 31 is disposed below a corresponding one of the two leg frames 11 and has a base portion 33 and two clamping arms 34. The base portion 33 has a connecting hole 331 longitudinally formed through the base portion 33 to face the bottom face of the corresponding leg frame 11. The two clamping arms 34 are respectively and pivotally connected to two sides of the base portion 33, are moved toward or away from each other. With reference to FIG. 7, the two clamping arms 34 of each clamping mount 31 engages with one of the two leg frames 11 of the pedestal 10 and two opposite sides of one of the multiple supporting rods 12. Then, with reference to FIG. 8, a corresponding supporting rod 12 is held and positioned on the two leg frames 11 by the clamping arms 34 of the two clamping mounts 31 to enable the corresponding supporting rod 12 to align with the cutting wheel 262 of the cutting device 20.

Furthermore, with reference to FIG. 6, each clamping arm 34 has a hook portion 341 and an avoidance slot 342. The hook portion 341 is formed on a free end of the clamping arm 34 toward a corresponding one of the two leg frames 11, and the hook portions 341 of the two clamping arms 34 engage with the corresponding leg frame 11. The avoidance slot 342 is formed in a side of the clamping arm 34 facing the corresponding leg frame 11 between the hook portion 341 and the base portion 33. With reference to FIG. 7, the pressing rod 32 is rotatably connected to the base portion 33 of the clamping mount 31 to move toward or away from the bottom face of the corresponding leg frame 11, and has a top end, a bottom end, a pushing disk 35, and a rotating handle 36. The top end of the pressing rod 32 extends above a top of the base portion 33 between the two clamping arms 34 via the connecting hole 331, and the pushing disk 35 is disposed on the top end of the pressing rod 32. The bottom end of the pressing rod 32 is disposed below the base portion 33, and the rotating handle 36 is disposed on the bottom end of the pressing rod 32. When the rotating handle 36 is rotated by a user, the pressing rod 32 is rotated relative to the base portion 33, and a distance between the pushing disk 35 and the bottom face of the corresponding leg frame 11 can be changed and adjusted.

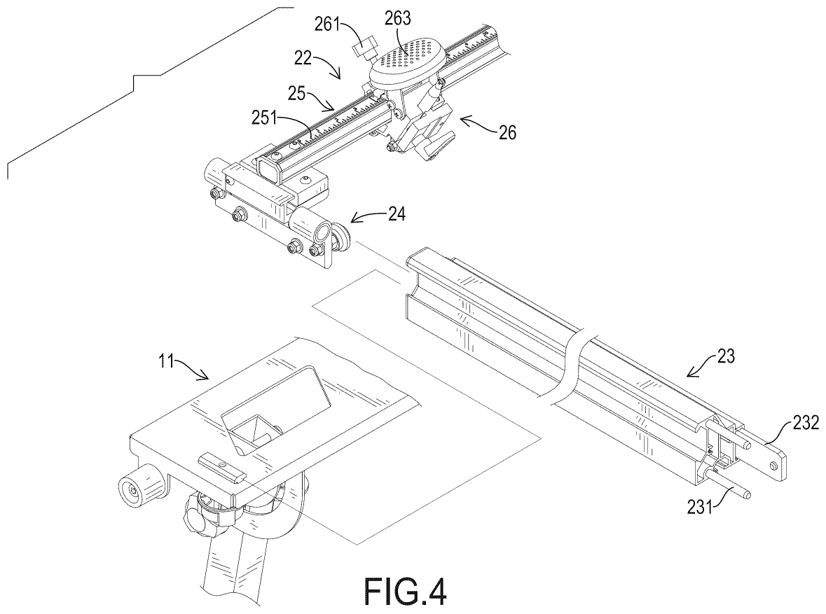

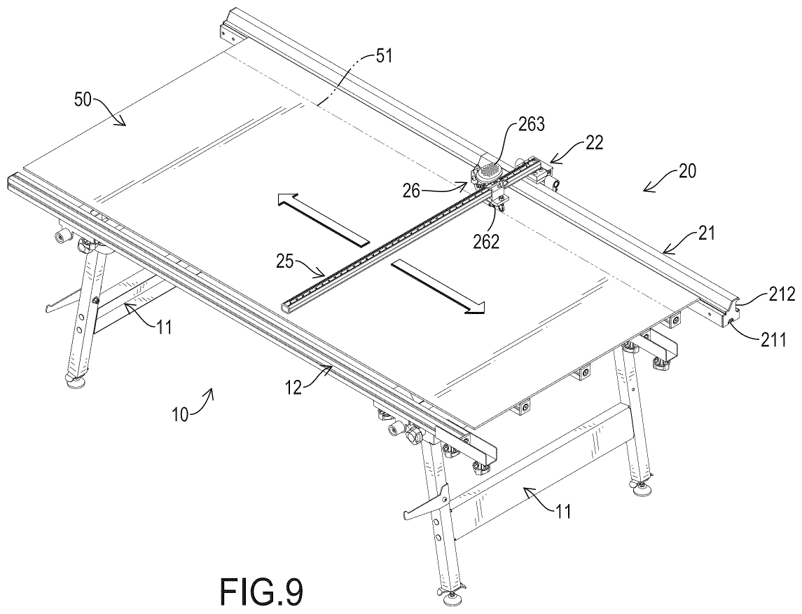

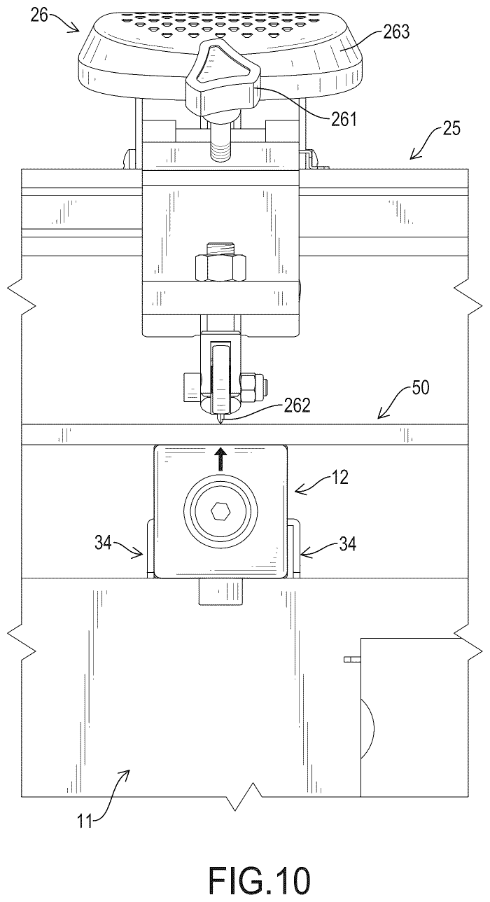

With reference to FIG. 4, when the cutting table for building materials of the present invention is in use, firstly, adjust the position of the cutting mount 26 relative to the measuring arm 25 according to the size to be cut to align the cutting mount 26 with the scale 251 required for cutting. At this time, after the position of the cutting mount 26 relative to the measuring arm 25 is fixed by the fastener 261, with reference to FIG. 5, one of the supporting rods 12 is moved to align with the cutting wheel 262 of the cutting mount 26 to provide a supporting effect during subsequent cutting. After the corresponding supporting rod 12 aligns with the cutting wheel 262, with reference to FIGS. 6, 7, and 8, the two camping mounts 31 are respectively pushed to move toward the two leg frames 11 to engage the corresponding supporting rod 12 by the clamping arms 34. By rotating the two rotating handles 36, the pushing disks 35 of the two pressing rods 32 are respectively pressed against the bottom faces of the two leg frames 11, so that the corresponding supporting rod 12 can be positioned between the two leg frames 11 and aligned with the cutting wheel 262 of the cutting mount 26. Then, with reference to FIG. 9, a building material 50 to be cut is placed on the multiple supporting rods 12 of the pedestal 10, as shown in FIG. 2, the operating stem 263 is pushed, and the pulleys 24 are rotated relative to the pulley grooves 212 of the track base 21, so that the cutting mount 26 is driven to move relative to the building material 50 through the measuring arm 25, and then a cutting line 51 is formed on the building material 50 by the cutting wheel 262. During the above-mentioned cutting process, with reference to FIG. 10, the corresponding supporting rod 12 aligning with the cutting wheel 262 can provide a support effect to the building material 50 to avoid breakage or fracture during the cutting process, so that the building material 50 can be cut conveniently and quickly.

According to the above-mentioned structural relationships and features of the cutting table for building materials of the present invention, in use, the user no longer needs to squat on the ground to place and cut the building material 50. Instead, the user only needs to place the building material 50 on the multiple supporting rods 12 of the pedestal 10, and the building material 50 can be cut by moving the cutting mount 26 relative to the track base 21. The operation is quite convenient, and the building material 50 mounted on the pedestal 10 can effectively prevent the user from colliding with the building material 50 or surrounding objects, thereby preventing the user from being injured or the building material 50 from being damaged or broken, effectively resolving safety and usage concerns, thereby providing a cutting table that facilitates ease in cutting, reduces collision damage, and is safe to use.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cutting table for building materials comprising:
a pedestal having
two leg frames disposed at a spaced interval and faced to each other, and each one of the two leg frames having a top face; and
multiple supporting rods disposed on the top faces of the two leg frames at spaced intervals;
a cutting device connected to the pedestal and having
a track base having a pulley groove formed in an outer side of the track base away from the multiple supporting rods and extending along a length direction of the track base; and
a cutter slidably connected to the track base and having
multiple pulleys rotatably disposed at spaced intervals on an inner side of the cutter and slidably mounted in the pulley groove of the track base such that the cutter is slid relative to the track base by the multiple pulleys;
a measuring arm transversally disposed on a top side of the cutter, crossing the track base, and extending above the pedestal; and
a cutting mount movably mounted on the measuring arm and having a cutting wheel rotatably disposed on a bottom of the cutting mount and facing to one of the multiple supporting rods; and
at least one clamping device connected to the pedestal and having
a clamping mount disposed below one of the two leg frames and having
a base portion; and
two clamping arms respectively and pivotally connected to two sides of the base portion, and engaging with the corresponding one of the two leg frames of the pedestal and two opposite sides of the corresponding one of the multiple supporting rods that is faced to the cutting wheel; and
a pressing rod rotatably connected to the base portion of the clamping mount to move toward or away from a bottom face of the corresponding one of the two leg frames, and selectively abutted against the bottom face the corresponding one of the two leg frames.

2. The cutting table for building materials as claimed in claim 1, wherein
the cutting table has two said clamping devices;
the two clamping devices are respectively disposed at and engage with the two leg frames, and engage with one of the multiple supporting rods;
the clamping arms of the two clamping mounts of the two clamping devices engage with the two sides of the corresponding one of the multiple supporting rods to hold the corresponding supporting rod securely on two top faces of the two leg frames; and
the cutting wheel of the cutting mount faces the corresponding supporting rod that is held by the clamping arms of the two clamping mounts of the two clamping devices.

3. The cutting table for building materials as claimed in claim 2, wherein
each one of the two clamping arms of the two clamping mounts of the two clamping devices has a hook portion formed on a free end of the clamping arm toward a corresponding one of the two leg frames;
the two hook portions of the two clamping arms of of the clamping mount of each one of the two clamping devices engages with the corresponding one of the two leg frames;
an avoidance slot formed in a side of the clamping arm facing the corresponding one of the two leg frames between the hook portion and the base portion of the clamping mount.

4. The cutting table for building materials as claimed in claim 3, wherein
each one of the two leg frames has
a connecting block disposed on the top face of the leg frame adjacent to a side of the leg frame; and
a rotating knob disposed on the bottom face of the leg frame and connected to the connecting block such that the connecting block is moved toward or away from the top face of the leg frame by rotating the rotating knob relative to the leg frame;
the track base has a connecting recess formed in a bottom side of the track base, extending along the length direction of the track base, and connected to the two connecting blocks of the two leg frames; and
the track base is securely mounted on the top faces of the two leg frames by rotating the two rotating knobs to respectively enable the two connecting blocks to respectively move toward the top faces of the two leg frames.

5. The cutting table for building materials as claimed in claim 1, wherein
the track base is formed by multiple rails connecting to each other;
one of two adjacent rails of the multiple rails has multiple inserting pins and multiple positioning slices; and
the other one of the two adjacent rails of the multiple rails has multiple pin holes and multiple positioning slots; and
the two adjacent rails are connected to each other by the inserting pins inserted into the pin holes and the positioning slices mounted in the positioning slots.

6. The cutting table for building materials as claimed in claim 2, wherein
the track base is formed by multiple rails connecting to each other;
one of two adjacent rails of the multiple rails has multiple inserting pins and multiple positioning slices; and
the other one of the two adjacent rails of the multiple rails has multiple pin holes and multiple positioning slots; and
the two adjacent rails are connected to each other by the inserting pins inserted into the pin holes and the positioning slices mounted in the positioning slots.

7. The cutting table for building materials as claimed in claim 3, wherein
the track base is formed by multiple rails connecting to each other;
one of two adjacent rails of the multiple rails has multiple inserting pins and multiple positioning slices; and
the other one of the two adjacent rails of the multiple rails has multiple pin holes and multiple positioning slots; and
the two adjacent rails are connected to each other by the inserting pins inserted into the pin holes and the positioning slices mounted in the positioning slots.

8. The cutting table for building materials as claimed in claim 4, wherein
the track base is formed by multiple rails connecting to each other;
one of two adjacent rails of the multiple rails has multiple inserting pins and multiple positioning slices; and
the other one of the two adjacent rails of the multiple rails has multiple pin holes and multiple positioning slots; and
the two adjacent rails are connected to each other by the inserting pins inserted into the pin holes and the positioning slices mounted in the positioning slots.

9. The cutting table for building materials as claimed in claim 5, wherein the measuring arm has a scale formed on a top side of the measuring arm for cutting.

10. The cutting table for building materials as claimed in claim 6, wherein the measuring arm has a scale formed on a top side of the measuring arm for cutting.

11. The cutting table for building materials as claimed in claim 7, wherein the measuring arm has a scale formed on a top side of the measuring arm for cutting.

12. The cutting table for building materials as claimed in claim 8, wherein the measuring arm has a scale formed on a top side of the measuring arm for cutting.

13. The cutting table for building materials as claimed in claim 9, wherein the cutting mount has
a fastener connected to the cutting mount and selectively abutting against the measuring arm to hold the cutting mount securely on the measuring arm; and
an operating stem disposed on a top of the cutting mount for pushing by a user to push the cutting mount via the pulleys, such that the cutter is moved along the track base relative to the pedestal.

14. The cutting table for building materials as claimed in claim 10, wherein the cutting mount has
a fastener connected to the cutting mount and selectively abutting against the measuring arm to hold the cutting mount securely on the measuring arm; and
an operating stem disposed on a top of the cutting mount for pushing by a user to push the cutting mount via the pulleys, such that the cutter is moved along the track base relative to the pedestal.

15. The cutting table for building materials as claimed in claim 11, wherein the cutting mount has
a fastener connected to the cutting mount and selectively abutting against the measuring arm to hold the cutting mount securely on the measuring arm; and
an operating stem disposed on a top of the cutting mount for pushing by a user to push the cutting mount via the pulleys, such that the cutter is moved along the track base relative to the pedestal.

16. The cutting table for building materials as claimed in claim 12, wherein the cutting mount has
a fastener connected to the cutting mount and selectively abutting against the measuring arm to hold the cutting mount securely on the measuring arm; and
an operating stem disposed on a top of the cutting mount for pushing by a user to push the cutting mount via the pulleys, such that the cutter is moved along the track base relative to the pedestal.

17. The cutting table for building materials as claimed in claim 13, wherein
the base portion of the clamping mount of each one of the two clamping devices has a connecting hole longitudinally formed through the base portion to face the bottom face of a corresponding one of the two leg frames; and
the pressing rod of the clamping mount of each one of the two clamping devices has a top end extending above a top of the base portion between the two clamping arms of the clamping mount via the connecting hole.

18. The cutting table for building materials as claimed in claim 14, wherein
the base portion of the clamping mount of each one of the two clamping devices has a connecting hole longitudinally formed through the base portion to face the bottom face of a corresponding one of the two leg frames; and
the pressing rod of the clamping mount of each one of the two clamping devices has a top end extending above a top of the base portion between the two clamping arms of the clamping mount via the connecting hole.

19. The cutting table for building materials as claimed in claim 17, wherein
the pressing rod of the clamping mount of each one of the two clamping devices has
a bottom end disposed below the base portion;
a pushing disk disposed on the top end of the pressing rod; and
a rotating handle disposed on the bottom end of the pressing rod; and
when the rotating handle is rotated by a user, the pressing rod is rotated relative to the base portion, and a distance between the pushing disk and the bottom face of a corresponding one of the two leg frames is changed and adjusted.

20. The cutting table for building materials as claimed in claim 18, wherein
the pressing rod of the clamping mount of each one of the two clamping devices has
a bottom end disposed below the base portion;
a pushing disk disposed on the top end of the pressing rod; and
a rotating handle disposed on the bottom end of the pressing rod;
and
when the rotating handle is rotated by a user, the pressing rod is rotated relative to the base portion, and a distance between the pushing disk and the bottom face of a corresponding one of the two leg frames is changed and adjusted.
